(19) United States
(12) Patent Application Publication
(10) Pub. No.: US 2022/0394184 A1
(43) Pub. Date: Dec. 8, 2022

(54) METHOD AND APPARATUS FOR GENERATING ULTRA-HIGH-QUALITY DIGITAL DATA

(71) Applicant: ELECTRONICS AND TELECOMMUNICATIONS RESEARCH INSTITUTE, Daejeon (KR)

(72) Inventors: Young-Suk YOON, Cheongju-si, Chungcheongbuk-do (KR); Ju Young KIM, Daejeon (KR); Jae-Ho LEE, Daejeon (KR)

(73) Assignee: ELECTRONICS AND TELECOMMUNICATIONS RESEARCH INSTITUTE, Daejeon (KR)

(21) Appl. No.: 17/831,607

(22) Filed: Jun. 3, 2022

(30) Foreign Application Priority Data
Jun. 4, 2021 (KR) 10-2021-0072665

(51) Int. Cl. H04N 5/232; G06T 7/73; G06V 10/22

(52) U.S. Cl. CPC H04N 5/23299; G06T 7/74; G06V 10/23; H04N 5/23229; G06V 2201/07; G06T 2207/30244

(57) ABSTRACT

Provided are a method and apparatus for generating ultra-high-quality digital data. A method for generating digital data includes identifying information on a target disposed at a specific position, controlling a movement of a first device to photograph two-dimensional image data for a partial region of the identified target, determining whether the two-dimensional image data for the partial region of the target photographed through a camera mounted on the first device corresponds to an entire region of the target, and controlling a movement of a second device loaded with the target when the two-dimensional image data for the partial region of the photographed target does not correspond to the entire region of the target.

### CROSS-REFERENCE TO RELATED APPLICATION

This application claims the benefit of Korean Patent Application No. 10-2021-0072665 filed on Jun. 4, 2021, in the Korean Intellectual Property Office, the entire disclosure of which is incorporated herein by reference for all purposes.

### BACKGROUND

### 1. Field of the Invention

One or more example embodiments relate to a method and apparatus for generating digital data, and more particularly, to a method and apparatus for generating ultra-high-quality n-dimensional digital data by acquiring high-quality two-dimensional image data of a target at various positions using a device with a movement that is controllable through a program.

### 2. Description of the Related Art

Recently, with the advent of the corona virus, a lot has changed, and the generalized and standardized “new normal” is gradually spreading. A direct, face-to-face viewing to experience a cultural heritage has been changing to an indirect, non-face-to-face viewing capable of experiencing the cultural heritage. In order to indirectly experience the cultural heritage, an actual cultural heritage needs to be generated as digital data, and a sophisticated operation needs to be performed in a process of generating digital data to improve quality of the generated digital data and increase immersion of visitors.

Recently, photographs taken as two-dimensional images are used to generate giga-pixel-level ultra-high-resolution two-dimensional images, photographs taken in various positions and postures while looking at a target are matched or fused, or three-dimensional scanning equipment is used to generate ultra-high-quality three-dimensional digital data.

As described above, in a method of acquiring ultra-high-quality n-dimensional digital data for a target according to a related art, a professional photographer manually takes a photograph and scans the photograph using a camera and scan equipment, or synchronizes multiple cameras to take a photograph at the same time, and then generates ultra-high-quality n-dimensional digital data using a computer vision technology.

However, in the former case among the above-described methods according to a related art, quality of n-dimensional digital data generated according to ability through experience and sense of the professional photographer or professional cameraman varies. In the latter case, many resources are required to accommodate a large number of cameras or other equipment.

### SUMMARY

Example embodiments provide a method and apparatus for generating ultra-high-quality n-dimensional digital data by acquiring two-dimensional image data of a target at various positions using a device with a movement that is controllable through a program.

According to an example embodiment, there is provided a method for generating digital data, the method including identifying information on a target disposed at a specific position, controlling a movement of a first device to photograph two-dimensional image data for a partial region of the identified target, determining whether the two-dimensional image data for the partial region of the target photographed through a camera mounted on the first device corresponds to an entire region of the target, and controlling a movement of a second device loaded with the target when the two-dimensional image data for the partial region of the photographed target does not correspond to the entire region of the target.

The identifying of the information on the target may include identifying a size of the target and a distance between the camera and the target using information collected through a sensor.

The controlling of the movement of the first device may include calculating a travel position, posture, and path of the first device so that a distance between the camera and the target is constant.

The controlling of the movement of the second device may include rotating the second device by a preset angle with respect to a central axis of the target.

The method may further include recording, as global coordinates, a position and posture of the camera moved by the first device, and the position and posture of the camera recorded as the global coordinates may be used to generate n-dimensional digital data of the target.

The recording may include calculating the position and posture of the camera as the global coordinates using (i) the position and posture of the camera mounted on the first device, (ii) an amount of rotation of the second device, and (iii) a distance between respective reference points for the first device and the second device.

According to another aspect, there is provided a method for generating digital data, the method including selecting one reference image data from among pieces of two-dimensional image data for an entire region of a target, determining neighboring image data for the selected reference image data, calculating respective feature points for the selected reference image data and the determined neighboring image data, and generating n-dimensional digital data by fusing the reference image data and the neighboring image data using a pair of matching feature points among the calculated feature points. The generating of the n-dimensional digital data may include generating n-dimensional digital data with further improved quality additionally using global coordinates for a position and posture of a camera that photographs the target.

The global coordinates for the position and posture of the camera may be calculated using (i) the position and posture of the camera mounted on a first device, (ii) an amount of rotation of a second device loaded with the target, and (iii) a distance between respective reference points for the first device and the second device.

The selecting of the reference image data may include selecting, as reference image data, two-dimensional image data with most feature points among the pieces of two-dimensional image data.

The determining of the neighboring image data may include selecting, as neighboring image data, two-dimensional image data spatiotemporally closest to the reference image data from among the pieces of two-dimensional image data.

According to still another aspect, there is provided an apparatus for generating digital data, the apparatus including a processor. The processor may be configured to identify information on a target disposed at a specific position, control a movement of a first device to photograph two-dimensional image data for a partial region of the identified target, determine whether the two-dimensional image data for the partial region of the target photographed through a camera mounted on the first device corresponds to an entire region of the target, and control a movement of a second device loaded with the target when the two-dimensional image data for the partial region of the photographed target does not correspond to the entire region of the target.

The processor may be configured to identify a size of the target and a distance between the camera and the target using information collected through a sensor.

The processor may be configured to calculate a travel position, posture, and path of the first device so that a distance between the camera and the target is constant.

The processor may be configured to rotate the second device by a preset angle with respect to a central axis of the target.

The processor may be configured to record, as global coordinates, a position and posture of the camera moved by the first device, and the position and posture of the camera recorded as the global coordinates may be used to generate n-dimensional digital data of the target.

The processor may be configured to calculate the position and posture of the camera as the global coordinates using (i) the position and posture of the camera mounted on the first device, (ii) an amount of rotation of the second device, and (iii) a distance between respective reference points for the first device and the second device.

According to still another aspect, there is provided an apparatus for generating digital data, the apparatus including a processor. The processor may be configured to select one reference image data from among pieces of two-dimensional image data for an entire region of a target, determine neighboring image data for the selected reference image data, calculate respective feature points for the selected reference image data and the determined neighboring image data, generate n-dimensional digital data by fusing the reference image data and the neighboring image data using a pair of matching feature points among the calculated feature points, and generate n-dimensional digital data with further improved quality additionally using global coordinates for a position and posture of a camera that photographs the target.

The global coordinates for the position and posture of the camera may be calculated using (i) the position and posture of the camera mounted on a first device, (ii) an amount of rotation of a second device loaded with the target, and (iii) a distance between respective reference points for the first device and the second device.

The processor may be configured to select, as reference image data, two-dimensional image data with most feature points among the pieces of two-dimensional image data.

The processor may be configured to select, as neighboring image data, two-dimensional image data spatiotemporally closest to the reference image data from among the pieces of two-dimensional image data.

Additional aspects of example embodiments will be set forth in part in the description which follows and, in part, will be apparent from the description, or may be learned by practice of the disclosure.

According to example embodiments, it is possible to generate ultra-high-quality n-dimensional digital data by acquiring high-quality two-dimensional image data of a target at various positions using a device with a movement that is controllable through a program.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a digital data generating system according to an example embodiment;

FIG. 2 is a diagram illustrating an example of photographing so that a distance between a camera and a target is constant according to an example embodiment;

FIG. 3 is a view showing a partial region of an entire region of a photographable target according to an example embodiment;

FIG. 4 is a flowchart illustrating a method for acquiring two-dimensional image data of a target according to an example embodiment;

FIG. 5 is a diagram illustrating a process of acquiring ultra-high-quality n-dimensional digital data using two-dimensional image data acquired based on FIG. 4 according to an example embodiment;

FIG. 6 is a diagram illustrating another example of a digital data generating system according to an example embodiment; and

FIG. 7 is a diagram illustrating still another example of a digital data generating system according to an example embodiment.

### DETAILED DESCRIPTION

Hereinafter, example embodiments will be described in detail with reference to the accompanying drawings.

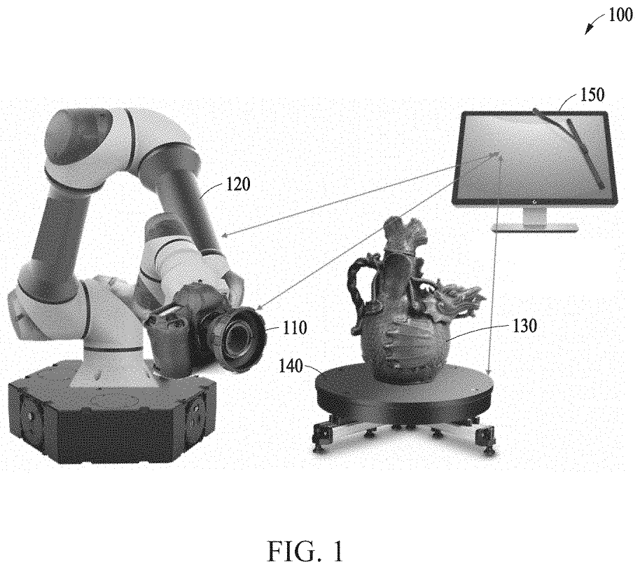

FIG. 1 is a diagram illustrating a digital data generating system according to an example embodiment.

For an item that is sensitive to an external shock, or a special or valuable item, such as a cultural heritage, contact with workers may need to be reduced as much as possible. In addition, when the item is analyzed and used for a special purpose, digital data may need to be generated in ultra-high quality including ultra-high resolution.

To this end, referring to FIG. 1, a digital data generating system 100 according example embodiments may include a digital data generating apparatus 150 that generates digital data of a target 130 by controlling movements of a first device 120 and a second device 140 through a first device 120 mounted with a camera 110, a second device 140 loaded with the target 130, and a program. The example of FIG. 1 illustrates a configuration for photographing and acquiring pieces of high-quality two-dimensional image data so as to generate ultra-high-quality three-dimensional digital data.

In this case, the first device 120 may need to be capable of creating various viewpoints and postures so as to acquire two-dimensional image data for an entire region of the target 130, and thus may support more than six degrees of freedom. The first device 120 may be installed in plurality, and may improve an acquisition speed of the two-dimensional image data by performing an operation in cooperation with each other. In this case, the number of first devices 120 that are installable may be increased or decreased according to a space, requirements, and the like.

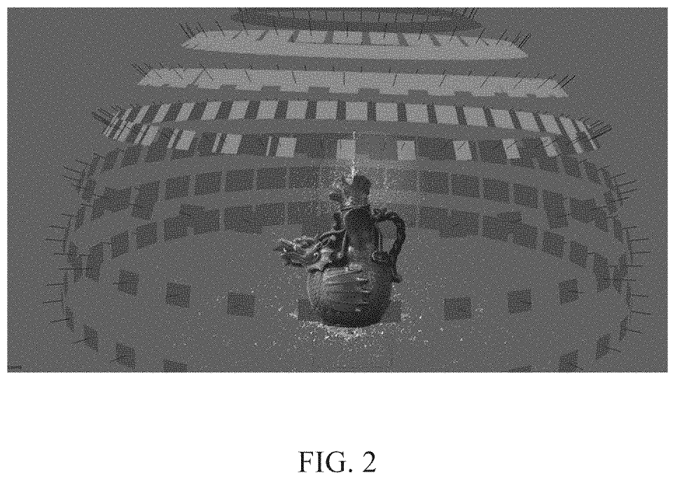

In the case of fusing two-dimensional image data of the target 130 that is uniformly photographed through a camera mounted on the first device 120, quality of generated ultra-high-quality three-dimensional digital data may be excellent when compared to a case of fusing non-uniform two-dimensional image data. In this case, uniform photographing may represent that a distance between the camera and the target 130 is constant, and ideally, may represent that two-dimensional image data is acquired in the form of a semi-sphere surrounding the target 130. FIG. 2 illustrates an example of photographing so that a distance between a camera and the target 130 is constant.

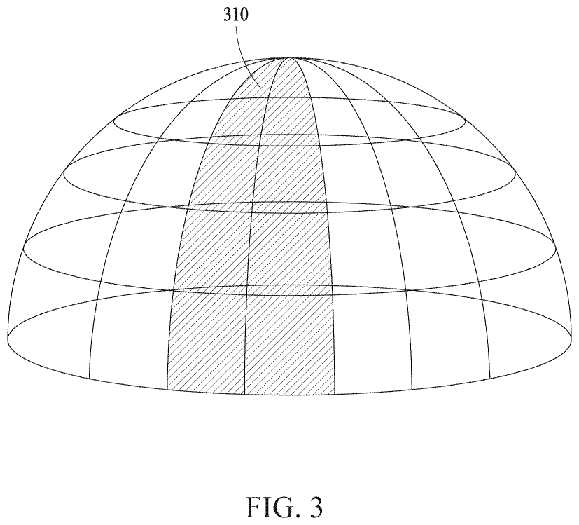

Here, when the first device 120 is not movable, a region of the target 130 that is photographable through a camera mounted on the first device 120 may be limited. Referring to FIG. 3, in a state where the first device 120 has no mobility and the target 130 is fixed, the camera mounted on the first device 120 may acquire partially acquire high-quality two-dimensional image data only for a partial region 310 of FIG. 3. An area of the partial region 310 may vary depending on a size of the target 130 and a reaching distance of the first device 120.

In this case, in order to acquire two-dimensional image data for a region other than the partial region 310 illustrated in FIG. 3, the first device 120 mounted with the camera may have mobility and make one rotation with respect to the target 130, thereby acquiring two-dimensional image data for an entire region of the target 130.

Conversely, the second device 140 may be loaded with the target 130, and may rotate by a preset angle with respect to a central axis of the target 130, thereby allowing the camera mounted on the first device 120 to acquire the two-dimensional image data for the entire region of the target 130.

Such movements of the first device 120 and the second device 140 may be controlled through the digital data generating apparatus 150, and the digital data generating apparatus 150 may generate n-dimensional digital data for the target 130 using the acquired two-dimensional image data for the entire region of the target 130.

The target 130 may be photographed in the form of a cylinder rather than a hemisphere due to characteristics and requirements of the first device 120, thereby acquiring the two-dimensional image data. In this case, when a partial region is made smallest using the concept of differentiation, the first device 120 may reciprocate in a vertical direction along a surface of the hemisphere or cylinder, and the second device 140 may minutely rotate, thereby photographing the two-dimensional image data capable of covering the surface of the corresponding hemisphere or cylinder in an overlapping manner.

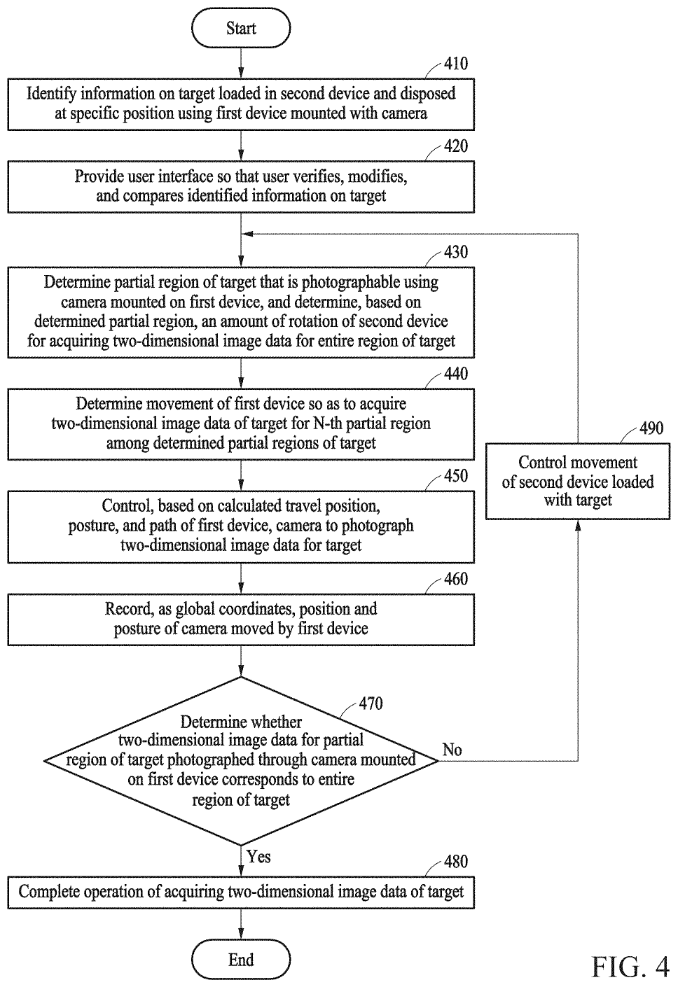

FIG. 4 is a flowchart illustrating a method for acquiring two-dimensional image data of a target according to an example embodiment.

In operation 410, the digital data generating apparatus 150 may identify information on the target 130 loaded in the second device 140 and disposed at a specific position using the first device 120 mounted with a camera. In this case, the digital data generating apparatus 150 may identify a size of the target 130 and a distance between the camera and the target 130 using an optical sensor, a distance sensor, a depth sensor, or the like disposed in the first device 120.

In operation 420, the digital data generating apparatus 150 may provide a user interface so that a user verifies, modifies, or compares the identified information on the target 130.

In operation 430, the digital data generating apparatus 150 may determine a partial region of the target 130 that is photographable using the camera mounted on the first device 120, and may determine, based on the determined partial region, an amount of rotation of the second device 140 for acquiring two-dimensional image data for an entire region of the target 130.

Then, in operation 440, the digital data generating apparatus 150 may determine a movement of the first device 120 so as to acquire two-dimensional image data of the target 130 for an N-th partial region among the partial regions of the target 130 determined in operation 430. In this case, the digital data generating apparatus 150 may calculate a travel position, posture, and path of the first device 120 so that the distance between the camera and the target 130 is constant for the N-th partial region.

In operation 450, the digital data generating apparatus 150 may control, based on the calculated travel position, posture, and path of the first device 120, the camera to photograph the two-dimensional image data for the target 130. In this case, the digital data generating apparatus 150 may control the first device 120 to have a predetermined stop time period after the first device completes travelling, thereby preventing the camera from shaking to acquire two-dimensional image data with further improved quality.

In operation 460, the digital data generating apparatus 150 may record, as global coordinates, a position and posture of the camera moved by the first device 120, and the position and posture recorded as the global coordinates may then be used to generate n-dimensional digital data of the target 130.

In this case, the global coordinates may be recorded to correspond to a global coordinate system or world coordinate system. More specifically, the global coordinates may be calculated using (i) the position and posture of the camera mounted on the first device 120, (ii) an amount of rotation of the second device 140, and (iii) a distance between respective reference points for the first device 120 and the second device 140. Here, the reference point of the first device 120 may represent a position reference point of the camera mounted on the first device 120, and the reference point of the second device 140 may represent a position reference point of a center of rotation of the second device 140.

In operation 470, the digital data generating apparatus 150 may determine whether the two-dimensional image data for the partial region of the target 130 photographed through the camera mounted on the first device 120 corresponds to the entire region of the target 130.

When it is determined that the two-dimensional image data for the partial region of the target 130 photographed through the camera corresponds to the entire region of the target 130, the digital data generating apparatus 150 may complete an operation of acquiring the two-dimensional image data of the target 130 in operation 480.

Conversely, when it is determined that the two-dimensional image data for the partial region of the target 130 photographed by the camera does not correspond to the entire region of the target 130, the digital data generating apparatus 150 may control a movement of the second device 140 loaded with the target 130 in operation 490. More specifically, the digital data generating apparatus 150 may control the second device 140 to rotate by a preset angle with respect to the center of rotation of the second device 140, that is, a central axis of the target 130, and may repeatedly perform operations 440 to 470, thereby acquiring the two-dimensional image data for the entire region of the target 130.

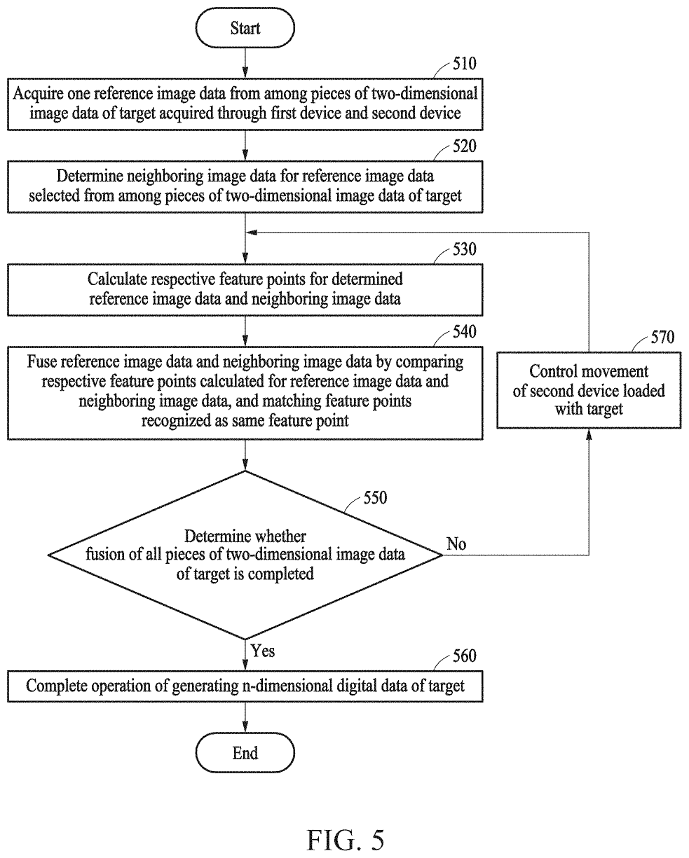

FIG. 5 is a diagram illustrating a process of acquiring ultra-high-quality n-dimensional digital data using two-dimensional image data acquired based on FIG. 4 according to an example embodiment.

In operation 510, the digital data generating apparatus 150 may select one reference image data from among pieces of two-dimensional image data of the target 130 acquired through the first device 120 and the second device 140. In this case, the digital data generating apparatus 150 may arbitrarily select one two-dimensional image data from among the pieces of two-dimensional image data of the target 130, and determine the two-dimensional image data as reference image data. Alternatively, the digital data generating apparatus 150 may select two-dimensional image data with most feature points from among the pieces of two-dimensional image data of the target 130, and determine the two-dimensional image data as the reference image data.

In operation 520, the digital data generating apparatus 150 may determine neighboring image data for the reference image data selected from among the pieces of two-dimensional image data of the target 130. In this case, the digital data generating apparatus 150 may select two-dimensional image data spatiotemporally closest to the reference image data from among the pieces of two-dimensional image data, and determine the two-dimensional image data as the neighboring image data.

In operation 530, the digital data generating apparatus 150 may calculate respective feature points for the determined reference image data and the neighboring image data. In this case, the feature point, which is a multi-dimensional vector value capable of representing a unique characteristic of the two-dimensional image data, may be calculated using various algorithms.

In operation 540, the digital data generating apparatus 150 may compare the respective feature points calculated for the reference image data and the neighboring image data, and match the feature points recognized as the same feature point, thereby fusing the reference image data and the neighboring image data. In this case, the digital data generating apparatus 150 may additionally use global coordinates for a position and posture of a camera that photographs the target 130 in fusing the reference image data and the neighboring image data, thereby generating n-dimensional digital data with further improved quality.

Then, in operation 550, the digital data generating apparatus 150 may determine whether fusion of all pieces of the two-dimensional image data of the target 130 is completed. When it is determined that fusion of all pieces of two-dimensional image data of the target 130 is completed, the digital data generating apparatus 150 may complete an operation of generating n-dimensional digital data of the target 130 in operation 560.

Conversely, when it is determined that fusion of all pieces of two-dimension image data of the target 130 is not completed, the digital data generating apparatus 150 may determine new neighbor image data among the pieces of two-dimensional image data of the target 130, and acquire the n-dimensional digital data of the target 130 by repeatedly performing operations 520 to 550 in operation 570.

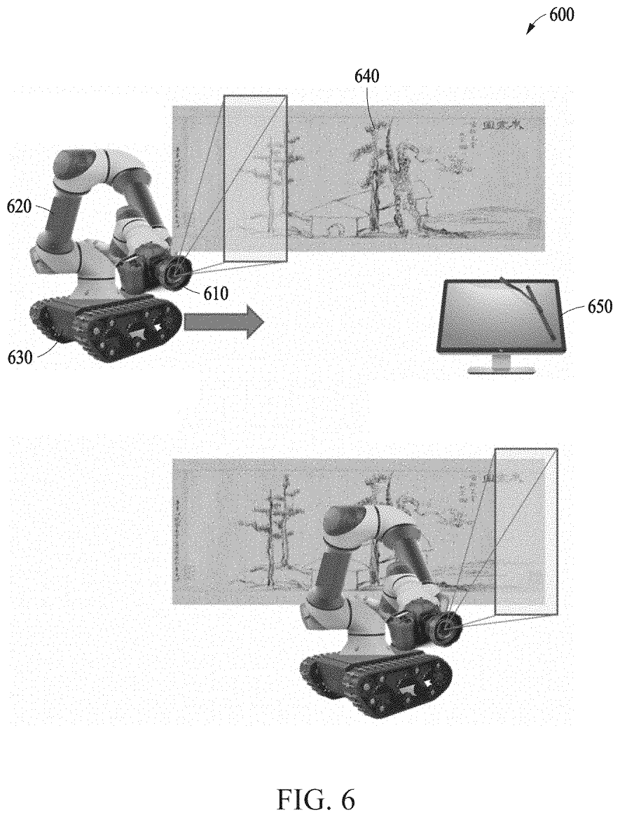

FIG. 6 is a diagram illustrating another example of a digital data generating system according to an example embodiment.

Referring to FIG. 6, a digital data generating system 600 provides a method for acquiring two-dimensional image data of a target 640 by allowing a first device 620 mounted with a camera 610 to be loaded on a movable second device 630. More specifically, the digital data generating apparatus 650 may set a partial region for the target 640, and control movements of the first device 620 and the second device 630 so as to acquire two-dimensional image data for the set partial region.

That is, the digital data generating apparatus 650 may acquire the two-dimensional image data for the partial region as the second device 630 loaded with the first device 620 moves along the target 640, and may control the movements of the first device 620 and the second device 630 until the acquired two-dimensional image data for the partial region is the same as two-dimensional image data for an entire region.

Then, the digital data generating apparatus 650 may generate ultra-high-quality two-dimensional digital data by performing a process of acquiring the n-dimensional digital data provided in FIG. 5. In the example of FIG. 6, the two-dimensional digital data may be generated because the target 640 is a painting work, but a type of the target 640 is not limited thereto and may vary.

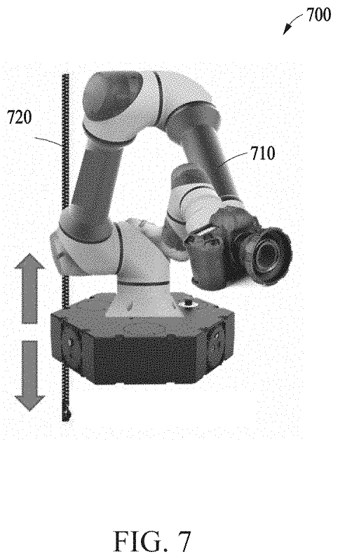

FIG. 7 is a diagram illustrating still another example of a digital data generating system according to an example embodiment.

Referring to FIG. 7, a first device 710 of a digital data generating system 700 may include an elevation apparatus 720 that is vertically movable on a base. Thus, the digital data generating system 700 may acquire high-quality two-dimensional image data even for a target such as a mural larger than a general painting work through the first device 710, and generate n-dimensional digital data using the acquired two-dimensional image data.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method for generating digital data, the method comprising:
identifying information on a target disposed at a specific position;
controlling a movement of a first device to photograph two-dimensional image data for a partial region of the identified target;
determining whether the two-dimensional image data for the partial region of the target photographed through a camera mounted on the first device corresponds to an entire region of the target; and
controlling a movement of a second device loaded with the target when the two-dimensional image data for the partial region of the photographed target does not correspond to the entire region of the target.

2. The method of claim 1, wherein the identifying of the information on the target comprises identifying a size of the target and a distance between the camera and the target using information collected through a sensor.

3. The method of claim 1, wherein the controlling of the movement of the first device comprises calculating a travel position, posture, and path of the first device so that a distance between the camera and the target is constant.

4. The method of claim 1, wherein the controlling of the movement of the second device comprises rotating the second device by a preset angle with respect to a central axis of the target.

5. The method of claim 1, further comprising:
recording, as global coordinates, a position and posture of the camera moved by the first device,
wherein the position and posture of the camera recorded as the global coordinates are used to generate n-dimensional digital data of the target.

6. The method of claim 5, wherein the recording comprises calculating the position and posture of the camera as the global coordinates using (i) the position and posture of the camera mounted on the first device, (ii) an amount of rotation of the second device, and (iii) a distance between respective reference points for the first device and the second device.

7. A method for generating digital data, the method comprising:
selecting one reference image data from among pieces of two-dimensional image data for an entire region of a target;
determining neighboring image data for the selected reference image data;
calculating respective feature points for the selected reference image data and the determined neighboring image data; and
generating n-dimensional digital data by fusing the reference image data and the neighboring image data using a pair of matching feature points among the calculated feature points,
wherein the generating of the n-dimensional digital data comprises generating n-dimensional digital data with further improved quality additionally using global coordinates for a position and posture of a camera that photographs the target.

8. The method of claim 7, wherein the global coordinates for the position and posture of the camera are calculated using (i) the position and posture of the camera mounted on a first device, (ii) an amount of rotation of a second device loaded with the target, and (iii) a distance between respective reference points for the first device and the second device.

9. The method of claim 7, wherein the selecting of the reference image data comprises selecting, as reference image data, two-dimensional image data with most feature points among the pieces of two-dimensional image data.

10. The method of claim 7, wherein the determining of the neighboring image data comprises selecting, as neighboring image data, two-dimensional image data spatiotemporally closest to the reference image data from among the pieces of two-dimensional image data.

11. An apparatus for generating digital data, the apparatus comprising:
a processor,
wherein the processor is configured to:
identify information on a target disposed at a specific position;
control a movement of a first device to photograph two-dimensional image data for a partial region of the identified target;
determine whether the two-dimensional image data for the partial region of the target photographed through a camera mounted on the first device corresponds to an entire region of the target; and
control a movement of a second device loaded with the target when the two-dimensional image data for the partial region of the photographed target does not correspond to the entire region of the target.

12. The apparatus of claim 11, wherein the processor is configured to identify a size of the target and a distance between the camera and the target using information collected through a sensor.

13. The apparatus of claim 11, wherein the processor is configured to calculate a travel position, posture, and path of the first device so that a distance between the camera and the target is constant.

14. The apparatus of claim 11, wherein the processor is configured to rotate the second device by a preset angle with respect to a central axis of the target.

15. The apparatus of claim 11, wherein the processor is configured to record, as global coordinates, a position and posture of the camera moved by the first device, and
the position and posture of the camera recorded as the global coordinates are used to generate n-dimensional digital data of the target.

16. The apparatus of claim 15, wherein the processor is configured to calculate the position and posture of the camera as the global coordinates using (i) the position and posture of the camera mounted on the first device, (ii) an amount of rotation of the second device, and (iii) a distance between respective reference points for the first device and the second device.
